(19) United States
(12) Patent Application Publication
(10) Pub. No.: US 2026/0259646 A1
(43) Pub. Date: Sep. 3, 2026

(54) METHOD, APPARATUS, DEVICE, AND STORAGE MEDIUM FOR INTERFACE INTERACTION

(71) Applicant: Beijing Zitiao Network Technology Co., Ltd., Beijing (CN)

(72) Inventors: Jiayi Xu, Beijing (CN); Xin Liu, Beijing (CN)

(21) Appl. No.: 19/555,689

(22) Filed: Mar. 3, 2026

(30) Foreign Application Priority Data
Mar. 3, 2025 (WO) PCT/CN2025/080268

(51) Int. Cl. G06F 3/0484; G06F 9/451

(52) U.S. Cl. CPC G06F 3/0484; G06F 9/451

(57) ABSTRACT

A method, an apparatus, a device, and a storage medium for interface interaction are provided. The method includes: presenting a viewing interface of a second application in response to a trigger by a current user for prompt information in a first application, wherein the prompt information is associated with a target user, a first association relationship between the current user and the target user in the first application satisfies a first condition, and a second association relationship between the current user and the target user in the second application fails to satisfy a second condition; presenting, in the viewing interface of the second application, media content posted by the target user in the second application; and providing a first control in association with the media content, the first control being configured to trigger a change of the second association relationship.

### CROSS REFERENCE

This application claims priority to PCT Application No. PCT/CN2025/080268, filed on Mar. 3, 2025, and entitled “METHOD, APPARATUS, DEVICE, AND STORAGE MEDIUM FOR INTERFACE INTERACTION”, the entirety of which is incorporated herein by reference.

### FIELD

Example embodiments of the disclosure generally relate to the field of computers, and in particular, to a method, an apparatus, a device, and a computer-readable storage medium for interface interaction.

### BACKGROUND

With the development of computer levels, electronic devices in various forms can greatly enrich the daily life for people. For example, people may interact with various applications in an electronic device, for example, following a user in a target application, etc., and it is expected to be able to use a more diverse and convenient manner of following during the interaction.

### SUMMARY

In a first aspect of the disclosure, a method for interface interaction is provided. The method includes: presenting a viewing interface of a second application in response to a trigger by a current user for prompt information in a first application, wherein the prompt information is associated with a target user, a first association relationship between the current user and the target user in the first application satisfies a first condition, and a second association relationship between the current user and the target user in the second application fails to satisfy a second condition; presenting, in the viewing interface of the second application, media content posted by the target user in the second application; and providing a first control in association with the media content, the first control being configured to trigger a change of the second association relationship.

In a second aspect of the disclosure, an apparatus for interface interaction is provided. The apparatus includes: an interface presenting module configured to present a viewing interface of a second application in response to a trigger by a current user for prompt information in a first application, wherein the prompt information is associated with a target user, a first association relationship between the current user and the target user in the first application satisfies a first condition, and a second association relationship between the current user and the target user in the second application fails to satisfy a second condition; a content presenting module configured to present, in the viewing interface of the second application, media content posted by the target user in the second application; and a control providing module configured to provide a first control in association with the media content, the first control being configured to trigger a change of the second association relationship.

In a third aspect of the disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the disclosure, a non-transitory computer-readable storage medium is provided. The non-transitory computer-readable storage medium stores a computer program thereon, and the computer program is executable by the processor to implement the method of the first aspect.

In a fifth aspect of the disclosure, there is provided a computer program product tangibly stored in a computer storage medium and including computer executable instructions that, when executed by a device, cause the device to perform the method of the first aspect.

It should be understood that the contents described in this content section is not intended to limit the key features or major features of the embodiments of the disclosure, nor is it intended to limit the scope of the disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the disclosure may be implemented;

FIGS. 2A-2D illustrate an example interface according to some embodiments of the disclosure;

FIG. 3 illustrates a flowchart of an example process of interface interaction according to some embodiments of the disclosure;

FIG. 4 illustrates a schematic structural block diagram of an example apparatus for interface interaction according to some embodiments of the disclosure; and

FIG. 5 illustrates a block diagram of an electronic device capable of implementing various embodiments of the disclosure.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms, and should not be construed as limitation to the embodiments set forth herein, but rather, these embodiments are provided for a more thorough and complete understanding of the disclosure. It should be understood that the drawings and embodiments of the disclosure are for exemplary purposes only and are not intended to limit the scope of the disclosure.

It should be noted that the title of any section / subsection provided herein is not limiting. Various embodiments are described throughout and any type of embodiments may be included in any section / subsection. Furthermore, the embodiments described in any section / subsection may be combined in any manner with any other embodiment described in the same section / subsection and / or different sections / subsections.

In the description of the embodiments of the disclosure, the terms “including” and the like should be understood as open-ended inclusion, i.e., “including but not limited to”. The term “based on” should be understood as “based at least in part on”. The terms “an embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the disclosure may relate to data of users, acquisition and / or use of data, and the like. These aspects all follow the corresponding laws and regulations and related regulations. In the embodiments of the disclosure, all data is collected, obtained, processed, treated, forwarded, used, etc. on the premise of the acknowledge and confirmation of the user. Accordingly, when implementing the embodiments of the disclosure, the types, the usage scope, the usage scenario, and the like of the data or information that may be involved should be notified to the user and obtain the authorization from the user in an appropriate manner according to the relevant laws and regulations. The specific notification and / or authorization manner may vary according to actual situations and application scenarios, and the scope of the disclosure is not limited in this respect.

According to the solutions in the present specification and the embodiments, if personal information processing is involved, the processing may be performed on the premise of having a legality basis (for example, obtaining consent of a personal information subject, or necessary for performing a fulfillment contract), and performed only within a specified or agreed range. A basic function for user usage would not be affected when the user rejects personal information other than necessary information required by the basic function.

According to the traditional solution, the current user needs to follow a corresponding target user in a details page of the media content, so that the user needs to spend a long time to make a following on the target user, thereby affecting the user experience.

Embodiments of the disclosure provide a solution for interface interaction. According to the solution, a viewing interface of a second application may be presented in response to a trigger by a current user for prompt information in a first application, wherein the prompt information is associated with a target user, a first association relationship between the current user and the target user in the first application satisfies a first condition, and a second association relationship between the current user and the target user in the second application does not satisfy a second condition; in the viewing interface of the second application, media content posted (i.e., published) by the target user in the second application is presented; and a first control is provided in association with the media content, and the first control is configured to trigger a change of the second association relationship.

In this way, the embodiments of the disclosure may support the current user to trigger the prompt information in the first application, jumping the interface to the viewing interface of the second application, and presenting the media content associated with the target user in the viewing interface. Further, the electronic device may provide a control for triggering a change of the second association relationship in association with the media content, so that the current user can quickly implement the change of the second association relationship with the target user in the second application, thereby facilitating the operation of the current user and improving the interaction efficiency of the interface.

Various example implementations of this solution are described in detail below in conjunction with the accompanying drawings.

### Example Environment

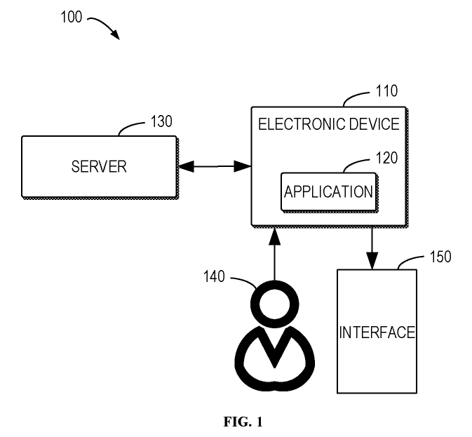

FIG. 1 illustrates a schematic diagram of an example environment 100 in which embodiments of the disclosure may be implemented. As shown in FIG. 1, the example environment 100 may include an electronic device 110.

In the example environment 100, the electronic device 110 may run an application 120 that supports interface interaction. The application 120 may be any suitable type of application for interface interaction, examples of which may include, but are not limited to: a video application, a social application, or other suitable application. A user 140 may interact with the application 120 via the electronic device 110 and / or its attachment device.

In the environment 100 of FIG. 1, if the application 120 is in an active state, the electronic device 110 may present, via the application 120, an interface 150 for supporting interface interaction.

In some embodiments, the electronic device 110 communicates with a server 130 to enable the supply of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR / AR device, a personal communication system (PCS) device, a personal navigation device, a personal digital assistant (PDA), an audio / video player, a digital camera / camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, may be a distributed system or a server cluster composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system / server, such as a mainframe, an edge computing node, a computing device in a cloud environment, and the like. The server 130 may provide background services for the application 120 that supports content presentation in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the disclosure are not limited in this aspect. In an embodiment of the disclosure, the server 130 and the electronic device 110 may implement signaling interaction through a communication connection between the server 130 and the electronic device 110.

It should be understood that structures and functions of various elements in the environment 100 are described for exemplary purposes only and do not imply any limitation to the scope of the disclosure.

Some example embodiments of the disclosure will be described below with continued reference to the accompanying drawings.

### Example Interaction

A process of example interface interaction according to embodiments of the disclosure will be described below with reference to the accompanying drawings.

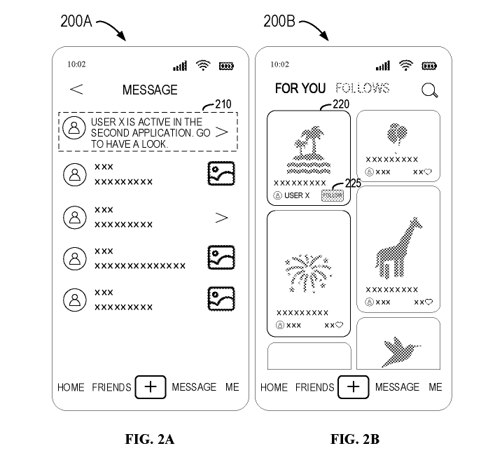

FIGS. 2A-2D illustrate example interfaces 200A-200D according to some embodiments of the disclosure. The interfaces 200A-200D may be provided by the electronic device 110 shown in FIG. 1.

FIG. 2A illustrates an example interaction interface according to some embodiments of the disclosure. As shown in FIG. 2A, the electronic device 110 may present a preset interface 200A of a first application. In some embodiments, such a preset interface 200A may include a message viewing interface of the first application. The electronic device 110 may present, in the message viewing interface, a historical interaction message of the current user in the first application. In addition, the electronic device 110 may also present, in the message viewing interface, prompt information 210 associated with a target user.

In some embodiments, the electronic device 110 may present the prompt information 210 in the preset interface 200A of the first application in response to the target user posting at least one media content via the second application within a preset time period. As an example, such a preset time period may be, for example, a recent period of time, for example, within one hour, one day, one month, or the like.

In some embodiments, such prompt information 210 may include a graphical identification associated with the second application (e.g., an icon of the second application); and / or a user identification associated with the target user (e.g., a nickname, and an avatar of the target user). Illustratively, such prompt information 210 may be, for example, “user X posts a work in the second application. Go to have a look”, “user X is very active in the second application. Go to have a look”, and the like.

In the embodiment of the disclosure, a first association relationship between the current user and the target user in the first application satisfies a first condition. As an example, such a first association relationship may, for example, indicate whether the target user is in a follow list of the current user in the first application. The first association relationship satisfying the first condition, for example, may indicate that the target user is in the follow list of the current user in the first application.

Further, in the embodiment of the disclosure, a second association relationship between the current user and the target user in the second application does not satisfy a second condition. As an example, such a second association relationship may, for example, indicate whether the target user is in the follow list of the current user in the second application. The second association relationship failing to satisfy the second condition may, for example, indicate that the target user is not in the follow list of the current user in the second application.

It can be seen from above that, the relationship between the current user and the target user may be that the current user has followed the target user in the first application, and the current user does not follow the target user in the second application.

It may be understood that the foregoing description is merely provided by using an example in which the association relationship is whether it is a following relationship, and in other embodiments, the association relationship between the current user and the target user may also be an appropriate relationship such as a friend relationship and a relationship about whether the user is a frequently viewed person.

In this way, after the target user posts the at least one media content in the second application, the electronic device may present the prompt information in the preset interface of the first application, so that the current user timely knows dynamics of the target user in the second application, thereby guiding the current user to view in the second application.

With continued reference to FIGS. 2A and 2B, in the embodiment of the disclosure, the electronic device 110 presents the viewing interface 200B of the second application in response to a trigger by the current user for the prompt information 210 in the first application. In some embodiments, such a trigger operation may include, for example, an appropriate type of operation such as a click operation, a double click operation, a hover operation, or a sliding operation. The disclosure is not intended to limit the form of the trigger operation.

Further, as shown in FIG. 2B, the electronic device 110 presents, in the viewing interface 200B of the second application, media content 220 posted by the target user in the second application. In some embodiments, to facilitate the current user to view the current dynamic of the target user, such media content 220 may be determined, for example, based on time information of at least one media content posted by the target user in the second application. As an example, the media content 220 may be, for example, media content recently posted by the target user. In order to facilitate the current user to view higher quality media content of the at least one media content posted by the target user. In other embodiments, such media content 220 may also be determined based on feedback information of other users for the at least one media content posted by the target user in the second application. As an example, the media content 220 may be, for example, media content having most likes, most comments, most collections, or most recommendations in the at least one media content posted by the target user in the second application.

Based on the foregoing manner, the electronic device 110 may determine to present, in the viewing interface of the second application, target media content in the at least one media content posted by the target user.

In some embodiments, the viewing interface 200B may be associated with an information flow (or a feed flow) in the second application, and the media content 220 posted by the target user in the second application may be presented in the information flow. In some embodiments, such an information flow may include a plurality of media contents posted by a plurality of users of the second application platform, and the current user may implement switching between the plurality of media contents in the information flow based on a content switching operation, for example, an up-slide operation. The current user may also interact with other users based on the media content, for example, like, comment on, or share the media content. In some embodiments, the information flow may include appropriate media works such as video works, image works, music works and the like.

Further, to facilitate the current user to view the media content 220 posted by the target user in the second application, in some embodiments, the media content 220 may be inserted into a preset position (for example, at a first place) in the information flow. As an example, such a preset position may be, for example, a first position in the information flow, that is, the media content 220 may be inserted into the first place of the information flow.

In order to enable the current user to browse media content of other users that are followed in the second application, in some embodiments, the information flow may further include a set of additional media content posted by a set of associated users in the second application, and an association relationship between the current user and the set of associated users in the second application satisfies the first condition. As an example, such a set of associated users may be, for example, a set of users that is followed by the current user in the second application, and such a set of additional media content may be, for example, a set of media content posted by a set of users that is followed by the current user in the second application.

In order for a user to more intuitively view content in an information flow, in some embodiments, such an information flow may be presented in a single view mode. To facilitate the user viewing more media content in a limited interface area, the electronic device 110 may also display media content 220 and / or such a set of additional media content in the information flow in a particular view mode (e.g., dual or multi-column view mode) in the viewing interface 200B.

Further, in order to facilitate the current user to establish the association relationship with the target user in the second application, in the embodiment of the disclosure, the electronic device 110 provides a first control 225 in association with the media content 220, and the first control 225 is configured to trigger a change of the second association relationship. Specifically, the electronic device 110 may provide the first control 225 in a cover image of the media content 220, for example. Illustratively, such a first control 225 may be, for example, a following control.

To facilitate the current user to more intuitively view the association relationship with the target user in the second application, or to guide the current user to change the association relationship with the target user in the second application, in some embodiments, the electronic device 110 may present a first element in the first control 225. Such a first element may be configured to indicate that the second association relationship between the current user and the target user does not satisfy a second condition, for example, the current user does not follow the target user in the second application. As an example, such a first element may, for example, show a word of “follow”.

In some embodiments, the electronic device 110 may provide an indication element indicating that the second association relationship is changed in response to the current user completing a change of the second association relationship via the first control 225. Specifically, the electronic device 110 may present an animation effect associated with the first control 225 in response to receiving a trigger by the current user for the first control 225. Taking FIGS. 2B and 2C as an example, such animation effect may, for example, indicate that a first element in the first control 225 is updated to a second element as shown in FIG. 2C, and in some embodiments, such a second element may be configured to indicate an indication element indicating that the second association relationship is changed. As an example, such a second element may, for example, show words of “followed” or “√”.

Further, in response to a completion of changing the second association relationship via the first control 225, the electronic device 110 may update an interface region corresponding to the first control 225 to a second control 230 as shown in FIG. 2D. In some embodiments, such a second control 230 may be configured to initiate a preset interactive operation associated with the media content 220. As an example, such preset interactive operation may be, for example, a like operation, a comment operation, a recommendation operation or a collection operation.

In some embodiments, in response to the prompt information 210 being associated with a set of users, the electronic device 110 may present a set of media content posted by such a set of users in the viewing interface 200B of the second application. Specifically, the electronic device 110 may present a set of media content (for example, media content a, media content b, and media content c) based on a degree of association between the current user and the set of users (for example, a user a, a user b, and a user c) in the first application, for example, the degree of association may indicate an interaction duration, an interaction frequency or the like of the current user and a set of users. As an example, in response to a degree of association between the current user and the user c in the first application being greater than a degree of association with the user b, and the degree of association with the user b being greater than a degree of association with the user a, the electronic device 110 may sequentially present, in the viewing interface 200B of the second application, the media content c posted by the user c, the media content b posted by the user b, and the media content a posted by the user a.

In other embodiments, such a set of media content may also be presented in the viewing interface 200B of the second application in a form of work set, for example. Further, in response to receiving a trigger by the current user for the work set, the electronic device 110 may sequentially present such a set of media contents. Further, the electronic device 110 may further provide a first control in a cover image of the work set, so as to change an association relationship between the current user and the set of users by one click/touch, for example, follow such a set of users by one touch.

In this way, the embodiments of the disclosure may support the current user to trigger the prompt information in the first application, jumping the interface to the viewing interface of the second application, and presenting the media content associated with the target user in the viewing interface. Further, the electronic device may provide a control for triggering a change of the second association relationship in association with the media content, so that the current user can quickly implement the change of the second association relationship with the target user in the second application, thereby facilitating the operation of the current user and improving the interaction efficiency of the interface.

### Example Process

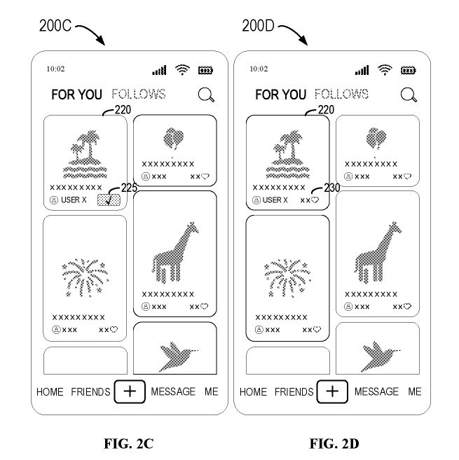

FIG. 3 illustrates a flowchart of an example interface interaction process 300 according to some embodiments of the disclosure. The process 300 may be implemented at the electronic device 110. The process 300 is described below with reference to FIG. 1.

As shown in FIG. 3, at block 310, the electronic device 110 presents a viewing interface of a second application in response to a trigger by the current user for the prompt information in the first application, wherein the prompt information is associated with a target user, a first association relationship between the current user and the target user in the first application satisfies a first condition, and a second association relationship between the current user and the target user in the second application does not satisfy a second condition.

At block 320, the electronic device 110 presents, in the viewing interface of the second application, media content posted by the target user in the second application.

At block 330, the electronic device 110 provides a first control in association with the media content, the first control being configured to trigger a change of the second association relationship.

In some embodiments, the viewing interface is associated with an information flow in the second application, the information flow including the media content.

In this way, the embodiments of the disclosure may support a user viewing more high-quality work content other than the media content, thereby improving the information acquisition efficiency of the user.

In some embodiments, the media content is inserted into a preset location in the information flow.

In this way, the embodiments of the disclosure may support the user to more intuitively view the media content, and improve the viewing efficiency and the user experience of the user.

In some embodiments, the information flow further includes a set of additional media content posted by a set of associated users in the second application, and an association relationship between the current user and the set of associated users in the second application satisfies the first condition.

In this way, the embodiments of the disclosure may support the user viewing work content of a set of users followed in the second application, so that the media content in the information flow can be enriched, and the information acquisition efficiency and browsing experience of the user can be improved.

In some embodiments, the process 300 further includes: providing an indication element indicating that the second association relationship is changed in response to a completion of changing the second association relationship via the first control.

In this way, the embodiments of the disclosure more intuitively view the association relationship between the current user and the target user in the second application, so that the user can be guided to interact.

In some embodiments, the process 300 further includes: updating an interface region corresponding to the first control to present a second control in response to a completion of changing the second association relationship via the first control, the second control being configured to initiate a preset interactive operation associated with the media content.

In this way, the embodiments of the disclosure may facilitate the user to intuitively view that the change of the second association relationship between the user and the target user has been completed, and the electronic device updates the interface region corresponding to the first control to present the second control, and may further improve the utilization rate of the interface region. In addition, the user may also implement interaction between the user and the media content based on the second control.

In some embodiments, the first application is configured to: present the prompt information in a preset interface of the first application in response to the target user posting at least one media content via the second application within a preset time period.

In this way, the embodiments of the disclosure may support the user to know dynamics of the target user in the second application in time, thereby guiding the user to view in the second application.

In some embodiments, the preset interface includes a message viewing interface of the first application.

In this way, the embodiments of the disclosure may support a user viewing the prompt information based on the message viewing interface, thereby improving the information acquisition efficiency of the user.

In some embodiments, the prompt information includes: a graphical identification associated with the second application; and / or a user identification associated with the target user.

In this way, the embodiments of the disclosure may enhance the intuitiveness and guidance of the prompt information based on the graphical identification associated with the second application and / or the user identification associated with the target user, thereby improving the interaction efficiency of the user and the prompt information.

### Example Apparatus and Device

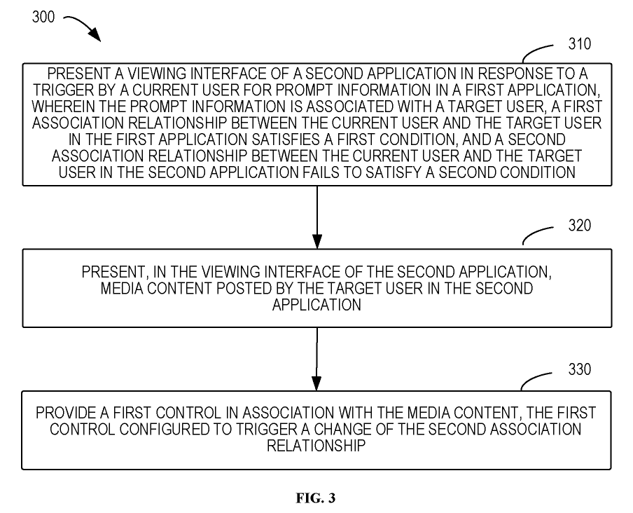

Embodiments of the disclosure also provide a corresponding apparatus for implementing the above method or process. FIG. 4 illustrates a schematic structural block diagram of an example apparatus 400 for interface interaction according to some embodiments of the disclosure. The apparatus 400 may be implemented or included in the electronic device 110. Various modules / components in the apparatus 400 may be implemented by hardware, software, firmware, or any combination thereof.

As shown in FIG. 4, the apparatus 400 includes an interface presenting module 410 configured to present a viewing interface of a second application in response to a trigger by a current user for prompt information in a first application, wherein the prompt information is associated with a target user, a first association relationship between the current user and the target user in the first application satisfies a first condition, and a second association relationship between the current user and the target user in the second application does not satisfy a second condition; a content presenting module 420 configured to present, in the viewing interface of the second application, media content posted by the target user in the second application; and a control providing module 430 configured to provide a first control in association with the media content, wherein the first control being configured to trigger a change of the second association relationship.

In some embodiments, the viewing interface is associated with an information flow in the second application, the information flow including the media content.

In some embodiments, the media content is inserted into a preset location in the information flow.

In some embodiments, the information flow further includes a set of additional media content posted by a set of associated users in the second application, and an association relationship between the current user and the set of associated users in the second application satisfies the first condition.

In some embodiments, the apparatus 400 further includes an element providing module configured to provide an indication element indicating that the second association relationship is changed in response to a completion of changing of the second association relationship via the first control.

In some embodiments, the apparatus 400 further includes a control updating module configured to update an interface region corresponding to the first control to present a second control in response to a completion of changing the second association relationship via the first control, the second control being configured to initiate a preset interactive operation associated with the media content.

In some embodiments, the first application is configured to: present the prompt information in a preset interface of the first application in response to the target user posting the at least one media content via the second application within the preset time period.

In some embodiments, the preset interface includes a message viewing interface of the first application.

In some embodiments, the prompt information includes: a graphical identification associated with the second application; and / or a user identification associated with the target user.

The modules included in the apparatus 400 may be implemented in various manners, including software, hardware, firmware, or any combination thereof. In some embodiments, one or more units may be implemented using software and / or firmware, such as machine-executable instructions stored on a storage medium. In addition to or as an alternative to machine-executable instructions, some or all of the modules in the apparatus 400 may be implemented, at least in part, by one or more hardware logic components. By way of example and not limitation, exemplary types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

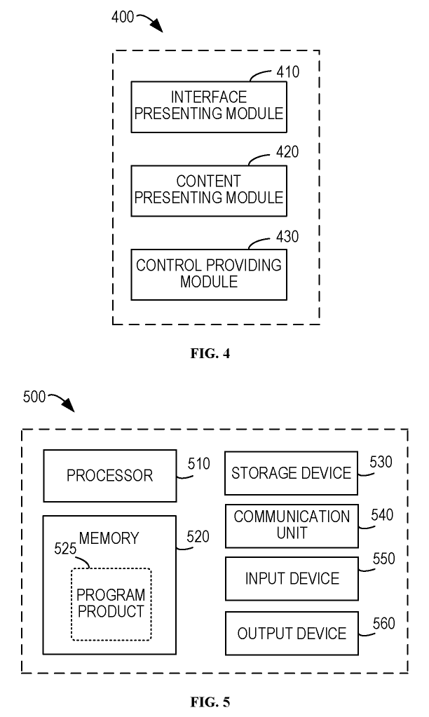

As shown in FIG. 5, the electronic device 500 is in a form of a general-purpose electronic device. Components of the electronic device 500 may include, but are not limited to, one or more processing units or processors 510, a memory 520, a storage device 530, one or more communication units 540, one or more input devices 550, and one or more output devices 560. The processor 510 may be an actual or virtual processor and capable of performing various processes according to programs stored in the memory 520. In a multiprocessor system, a plurality of processors execute computer-executable instructions in parallel to improve the parallel processing capability of the electronic device 500. The electronic device 500 shown in FIG. 5 may be configured to implement the electronic device 110 in FIG. 1.

The electronic device 500 generally includes a plurality of computer storage media. Such media may be any available media accessible to the electronic device 500, including, but not limited to, volatile and non-volatile media, removable and non-removable media. The memory 520 may be volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 530 may be a removable or non-removable medium and may include a machine-readable medium, such as a flash drive, magnetic disk, or any other medium, which may be capable of storing information and / or data and may be accessed within the electronic device 500.

The electronic device 500 may further include additional removable / non-removable, volatile / non-volatile storage media. Although not shown in FIG. 5, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the disclosure.

The communication unit 540 is configured to communicate with other electronic device through a communication medium. Additionally, the functionality of components of the electronic device 500 may be implemented in a single computing cluster or multiple computing machines capable of communicating through a communication connection. Thus, the electronic device 500 may operate in a networked environment using logical connections with one or more other servers, a network personal computer (PC), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, the external device such as a storage device, a display device, etc., communicates with one or more devices that enable a user to interact with the electronic device 500, or communicates with any device (e.g., a network card, a modem, etc.) that enables the electronic device 500 to communicate with one or more other electronic devices. Such communication may be performed via an input / output (I / O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, and the computer-executable instructions being executed by the processor to implement the method described above.

Aspects of the disclosure are described herein with reference to flowcharts and / or block diagrams of a method, an apparatus, a device, and a computer program product implemented in accordance with the disclosure. It should be understood that each block of the flowchart and / or block diagram, and combinations of blocks in the flowchart(s) and / or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions / acts specified in one or more blocks in the flowchart(s) and / or block diagram(s). These computer-readable program instructions may also be stored in a computer-readable storage medium that cause the computer, programmable data processing apparatus, and / or other devices to function in a particular manner, such that the computer-readable medium storing instructions includes an article of manufacture including instructions to implement aspects of the functions / acts specified in one or more blocks in the flowchart(s) and / or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on the computer, other programmable data processing apparatus, or other apparatus implement the functions / acts specified in one or more blocks in the flowchart(s) and / or block diagram(s).

The flowchart and block diagrams in the figures show an architecture, functionality, and operation that may be possibly implemented by a system, a method, and a computer program product according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagram(s) and / or flowchart(s), as well as combinations of blocks in the block diagram(s) and / or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for interface interaction comprising:
presenting a viewing interface of a second application in response to a trigger by a current user for prompt information in a first application, wherein the prompt information is associated with a target user, a first association relationship between the current user and the target user in the first application satisfies a first condition, and a second association relationship between the current user and the target user in the second application fails to satisfy a second condition;
presenting, in the viewing interface of the second application, media content posted by the target user in the second application; and
providing a first control in association with the media content, the first control configured to trigger a change of the second association relationship.

2. The method of claim 1, wherein the viewing interface is associated with an information flow in the second application, the information flow comprising the media content.

3. The method of claim 2, wherein the media content is inserted into a preset location in the information flow.

4. The method of claim 2, wherein the information flow further comprises a set of additional media content posted by a set of associated users in the second application, an association relationship between the current user and the set of associated users in the second application satisfying the first condition.

5. The method of claim 1, further comprising:
providing an indication element indicating that the second association relationship is changed in response to a completion of changing the second association relationship via the first control.

6. The method of claim 1, further comprising:
updating an interface region corresponding to the first control to present a second control in response to a completion of changing the second association relationship via the first control, the second control configured to initiate a preset interactive operation associated with the media content.

7. The method of claim 1, wherein the first application is configured to:
presenting the prompt information in a preset interface of the first application in response to the target user posting at least one media content via the second application within a preset time period.

8. The method of claim 7, wherein the preset interface comprises a message viewing interface of the first application.

9. The method of claim 1, wherein the prompt information comprises:
a graphical identification associated with the second application; and / or
a user identification associated with the target user.

10. An electronic device comprising:
at least one processor; and
at least one memory coupled to the at least one processor and storing instructions for execution by the at least one processor, the instructions, when executed by the at least one processor, causing the electronic device to perform acts comprising:
presenting a viewing interface of a second application in response to a trigger by a current user for prompt information in a first application, wherein the prompt information is associated with a target user, a first association relationship between the current user and the target user in the first application satisfies a first condition, and a second association relationship between the current user and the target user in the second application fails to satisfy a second condition;
presenting, in the viewing interface of the second application, media content posted by the target user in the second application; and
providing a first control in association with the media content, the first control configured to trigger a change of the second association relationship.

11. The electronic device of claim 10, wherein the viewing interface is associated with an information flow in the second application, the information flow comprising the media content.

12. The electronic device of claim 11, wherein the media content is inserted into a preset location in the information flow.

13. The electronic device of claim 11, wherein the information flow further comprises a set of additional media content posted by a set of associated users in the second application, an association relationship between the current user and the set of associated users in the second application satisfying the first condition.

14. The electronic device of claim 10, wherein the acts further comprise:
providing an indication element indicating that the second association relationship is changed in response to a completion of changing the second association relationship via the first control.

15. The electronic device of claim 10, wherein the acts further comprise:
updating an interface region corresponding to the first control to present a second control in response to a completion of changing the second association relationship via the first control, the second control configured to initiate a preset interactive operation associated with the media content.

16. The electronic device of claim 10, wherein the first application is configured to:
presenting the prompt information in a preset interface of the first application in response to the target user posting at least one media content via the second application within a preset time period.

17. The electronic device of claim 16, wherein the preset interface comprises a message viewing interface of the first application.

18. The electronic device of claim 10, wherein the prompt information comprises:
a graphical identification associated with the second application; and / or
a user identification associated with the target user.

19. A non-transitory computer-readable storage medium having stored thereon computer-executable instructions executable by a processor to perform acts comprising:
presenting a viewing interface of a second application in response to a trigger by a current user for prompt information in a first application, wherein the prompt information is associated with a target user, a first association relationship between the current user and the target user in the first application satisfies a first condition, and a second association relationship between the current user and the target user in the second application fails to satisfy a second condition;
presenting, in the viewing interface of the second application, media content posted by the target user in the second application; and
providing a first control in association with the media content, the first control configured to trigger a change of the second association relationship.

20. The non-transitory computer-readable storage medium of claim 19, wherein the viewing interface is associated with an information flow in the second application, the information flow comprising the media content.
